(19) United States
(12) Patent Application Publication
(10) Pub. No.: US 2009/0161364 A1
(43) Pub. Date: Jun. 25, 2009

(54) Prism lens and light fixture

(75) Inventors: Matthias Bremerich, Lennestadt (DE); Markus Gorres, Dortmund (DE)

Correspondence Address: K.F. ROSS P.C., 5683 RIVERDALE AVENUE, SUITE 203 BOX 900, BRONX, NY, 10471-0900, US

(73) Assignee: ERCO Leuchten GmbH

(21) Appl. No.: 12/009,163

(22) Filed: Jan. 16, 2008

(30) Foreign Application Priority Data
Dec. 20, 2007 (DE) 102007062523.7

(51) Int. Cl. F21V 5/02

(52) U.S. Cl. 362/268; 362/339

(57) ABSTRACT

Described and illustrated are, among other things, a prismatic lens (10) for a light fixture (25), comprising a light-entry side (11) and a light-exit side (12), and comprising a plurality of prisms (16, 16a, 16b, 16c, 16d, 16e, 16f, 16g, 17, 17a, 17b, 17c, 17d, 17e, 17f, 17g) arrayed in a structured manner and used for directing light along a preferred direction (V).

The invention is characterized in that at least partial regions (24, PF₂) of the light-exit side (12) have a light-diffusing design.

The invention relates firstly to a prismatic lens according to the preamble of claim 1.

Prismatic lenses having the features of the preamble of claim 1 are known from the prior art and have been used frequently by the present applicant, for example, for quite some time.

Known prismatic lenses have a plurality of prisms arrayed in a structured manner and used for directing light. Thus, for example, portions of light emanating from a light source that strike a light-entry side of the prismatic lens may be deflected as the result of passing through the prism. Under the assumption that parallel light beams or substantially parallel light beams strike the light-entry side of the essentially plate-shaped prismatic lens essentially perpendicularly, for example, the prisms are able to cause the light passing through the prismatic lens to be deflected or diverted along a preferred direction. The light beams passing through the prismatic lens exit the prismatic lens as a function of the selected geometry of the prisms, for example at an acute angle β relative to a straight line that is perpendicular, i.e. in the sense of a normal vector, to the light-exit side of the prismatic lens.

In certain applications it is desirable to even out the portions of light emitted from a light source before the light strikes the surface of a building or exterior space to be illuminated. To this end, it is known in the prior art to use diffuser elements, for example in the form of frosted lenses.

Proceeding from a prismatic lens of the prior art, the object of the invention is to refine a prismatic lens according to the preamble of claim 1 in such a way that the prismatic lens evens out light while maintaining its light-directing function at a high lighting efficiency.

This object is attained by the invention according to the features of claim 1, in particular the features of the characterizing part, and is accordingly characterized in that at least partial regions of the light-exit side have a light-diffusing design.

The principle of the invention consists essentially in a first step of combining the light-diffusing function of a separate element, known as such from the prior art, with a prismatic lens. According to the invention, in a second step this light-diffusing function is integrated into the prismatic lens.

The combination of a light-directing prismatic lens with an element having a light-diffusing function initially appears to be counterproductive. Whereas the prismatic lens of the prior art is used to deflect light in a preferred direction, light-diffusing elements specifically eliminate this preferred direction.

However, the invention recognizes that, as the result of special design of the light-exit side of the prismatic lens, the light-directing function may be essentially maintained while at the same time the light passing through the prismatic lens may be evened out.

The prismatic lens according to the invention has a light-diffusing design, at least in places, on its light-exit side. At least a portion of the light-exit side of the prismatic lens has a diffusely scattering design. In this manner the light-diffusing elements are integrated into the prismatic lens. As the result of designing or machining the light-exit side of the prismatic lens in the manner according to the invention, separate boundary surfaces are omitted. Losses in luminous flux as the result of reflections at boundary surfaces may thus be minimized. Providing partial regions of the light-exit side of the prismatic lens with a light-diffusing design achieves a much higher luminous flux efficiency than does a system in which a diffuser element is placed in the light path behind the prismatic lens and is provided by a separate element. Namely, such a separate diffuser element would provide additional boundary surfaces opposing the luminous flux, necessarily resulting in multiple reflections and accompanying losses in luminous flux.

The prismatic lens according to the invention may occupy a conceivably small installation space, since it may be designed with practically any given thickness. Finally, a prismatic lens according to the invention may also be manufactured economically.

Any element having an essentially planar or plate-shaped design, independent of its shape, may be regarded as a prismatic lens for a light fixture in the sense of the invention. The prismatic lens according to the invention may also have a slightly arched design. However, the prismatic lens may also have a flat design and lie in plane.

However, circular disk-shaped elements in particular, as well as annular elements may likewise be considered as prismatic lenses. The prismatic lens according to the invention may have a rectangular shape, or also a square shape, for example, or may have an irregular shape, for example a polygon. In particular, the shape of the prismatic lens may be matched to the shape of a light exit opening of a light fixture, so that the prismatic lens may be mounted in the light exit opening or close to the light exit opening of a light fixture. In this regard, the prismatic lens according to the invention may also replace a conventional glass cover plate.

The prismatic lens according to the invention comprises a light-entry side and a light-exit side. The side of the prismatic lens facing the light source or the multiple light sources is referred to as the light-entry side. The side of the prismatic lens facing the surface to be illuminated is referred to as the light-exit side.

The prismatic lens may have a thickness of several millimeters, for example. In the case of a circular disk-shaped prismatic lens, the longitudinal or transverse extension of its diameter may be between 2 and 150 centimeters, for example.

The prismatic lens according to the invention has a plurality of prisms arrayed in a structured manner for directing light along a preferred direction. An optical prism with a wedge shape, and therefore having two surfaces that are mutually oriented in a non-plane-parallel manner, is understood to be a prism in the sense of the invention. Whereas in physics an optical prism is typically used for the spectral splitting of white light, such a spectral splitting of color does not occur in the prismatic lens according to the invention. In this case, due to the plurality of prisms provided and the configuration of an actual light source having a continuous or quasi-continuous spectrum in the visible region, and due to the practically unlimited number of light beams with a practically unlimited number of directional variants, blending is achieved such that the prismatic lens according to the present patent application produces little or no visible color effects. The color of light entering the prismatic lens corresponds to the color of light exiting the prismatic lens.

Although spectral splitting by the prism does not play a significant role in the prismatic lens according to the invention, deflection of the light beam through the prism, like a conventional optical prism in physics, is accorded great importance in the present invention. As a result of the entry and exit surfaces of the prism being inclined at an angle with respect to one another, light beams are deflected due to the differing indices of refraction of the prism medium and air. The prismatic lens is preferably oriented with respect to the light source in such a way that the beams from the light source falling on the light-entry side of the prismatic lens strike essentially in parallel, in any case as an approximation thereto, or at least significant portions of the light strike in parallel. The configuration of the prisms causes this light to be deflected, so that the light beams leave the light-exit side of the prismatic lens along a preferred direction.

In the prismatic lens according to the invention, the prisms are arrayed in a structured manner. This means that the prisms are not randomly oriented, but instead are arrayed such that they ensure that light is actually directed along a preferred direction.

In the case of a prismatic lens according to the invention having, for example, an essentially rectangular shape, and comprising a plurality of prisms that all extend along parallel straight lines, it is possible, for example, for all beams perpendicularly striking the light-entry side of the prismatic lens to be deflected by an angle β with respect to a vector normal to the light-exit side, and to exit the prismatic lens. In this case, all light beams emerging from the prismatic lens are parallel, so that in fact a preferred direction is obtained along which light is directed through the prismatic lens.

Achieving such light guiding requires a special configuration of the numerous prisms that in the example just described is produced by aligning the prisms in parallel.

However, in the sense of the present invention radial light deflection, for example, may also be understood as a preferred direction. Thus, for example, for a circular disk-shaped prismatic lens designed according to the invention the prisms are arranged concentrically. The prisms then extend along concentric circular rings. In this case, all the parallel light beams that perpendicularly strike the light-entry side of the prismatic lens are outwardly deflected in a rotationally symmetrical manner by a specified deflection angle relative to a line parallel to a longitudinal center axis of the prismatic lens extending along a normal vector.

Thus, a patterned configuration of the prisms requires light deflection that can actually be measured, of the parallel light beams perpendicularly striking the light-entry side of the prismatic lens at a specified angle or angular range.

However, a structured or patterned configuration of the prisms in the sense of the invention does not necessarily require axially longitudinally extending, parallel prisms or concentrically arrayed prism rings. In fact, a configuration of numerous small prisms that at first glance might appear to have a random effect and nonuniform positioning, may also represent a structured configuration of the prisms in the sense of the invention when the plurality of prisms as a whole is able to achieve a distinct guiding of light along a preferred direction.

The prismatic lens according to the invention may have prisms on the light-entry side and/or prisms on the light-exit side. As viewed along a cross section of the prismatic lens, a sawtooth-like structure on one or both sides of the prismatic lens may result. In particular, the surface of the prisms may directly constitute the light-entry side or the light-exit side of the prismatic lens.

According to the invention, at least partial regions of the light-exit side of the prismatic lens have a light-diffusing design. This means that either only a portion of the light-exit side or the entire light-exit side of the prismatic lens may have a light-diffusing design. If only a portion of the total surface of the light-exit side has a light-diffusing design, multiple light-diffusing partial regions may be combined or insularly separated from one another.

Preferably, the light-diffusing partial regions of the light-exit side likewise have a structured configuration. It is also advantageous to match the structured configuration of the light-diffusing partial regions to the structured configuration of the prisms.

In the sense of the invention, a light-diffusing design of partial regions of the light-exit side means that measures are taken as the result of which the portions of light that pass through the prismatic lenses and strike these partial regions are at least partially scattered by diffusing structures. Nonuniform surface shapes such as surface roughness, for example, may be considered as diffusing structures. Alternatively, microlenses may be provided on the light-exit side. In particular, the diffusing structures extend along the surface of the prisms.

It is particularly advantageous to provide the diffusing structures only along certain prism surfaces. The prisms are advantageously truncated, whereby the diffusing structures are provided only along the truncated surfaces of the prisms.

The light-diffusing design according to the invention of partial regions of the light-exit side of the prismatic lens also includes configurations in which separate bodies, in particular films such as adhesive films, are directly joined to the prismatic lens, or in any case are situated adjacent to same. For example, thin, translucent films may be adhesively bonded to the light-exit side of the prismatic lens or affixed to the prismatic lens by other suitable means. As the result of directly joining the film to the prismatic lens, when suitable affixing means are used it is likewise possible to avoid or eliminate additional boundary surfaces and the accompanying reflection losses. The side of the film facing away from the light source, or optionally also the side of the film facing the light source, may be roughened or provided with appropriate diffusing structures to achieve a light-scattering effect. In this embodiment as well, the diffusing structures are integrated into the prismatic lens in the sense of light-diffusing means.

According to one advantageous embodiment of the invention, the prisms are longitudinally elongated. This means that the prisms have an essentially constant cross section that extends along a straight line or a circular path. Cylindrical bodies are preferred. This allows a structured configuration of the prisms and a high level of defined light guiding along a preferred direction to be obtained in a particularly simple manner.

According to a further advantageous embodiment of the invention, each of the prisms extends along a straight line. This design also includes the case that the prisms extend along multiple parallel straight lines. This configuration is particularly advantageous for a prismatic lens having a rectangular shape.

It is also advantageous for the respective prisms to extend along a circle. Multiple prisms may extend along concentric circles. This design is particularly advantageous for a prismatic lens having an essentially annular or circular disk shape. In this manner an essentially rotationally symmetrical guiding of light may also be obtained.

It is also advantageous to provide the prisms on the light-entry side of the prismatic lens. This allows light to be directed while achieving a particularly large deflection angle when additional prisms are provided on the light-exit side of the prismatic lens. This embodiment of the invention also allows diffusing structures to be attached in a particularly simple manner to the light-exit side of the prismatic lens that in this embodiment may also be kept planar. For example, a light-diffusing film may be adhesively bonded along the entire surface of the light-exit side of the prismatic lens. The film itself may, for example, be structured in different regions and may have regions that diffuse light as well as regions that admit light without causing light diffusion. Similarly, the film could have regions that diffuse the light intensely, and regions that diffuse the light to a lesser extent.

According to a further advantageous embodiment of the invention, the prisms are provided on the light-exit side of the prismatic lens. This allows light-diffusing structures to be attached directly to the light-exit side.

It is also advantageous for the prisms to be truncated. The prisms, which have an essentially wedge-shaped, i.e. triangular, cross section, are advantageously oriented with their base, i.e. with their longest base side, with respect to a center plane of the prismatic lens lying between the light-exit side and the light-entry side of the prismatic lens. Any conventional prism has two prism surfaces that extend outwardly from the base and intersect in an imaginary straight line. When a truncated prism is used, the two prism surfaces are joined by a surface that, referred to below as a truncated surface, is aligned parallel to the base of the prism.

The configuration of truncated prisms allows light-diffusing partial regions of the light-exit side to be provided in a particularly advantageous and simple manner. Thus, for example, diffusing structures may be provided on the truncated surfaces. Alternatively or additionally, light-diffusing structures may be provided on a prism surface.

Finally, light-diffusing structures of different types may also be provided on the light-exit side of the prismatic lens. For example, light-diffusing structures of the first type may be provided along first partial regions, for example on the truncated surfaces, and light-diffusing structures of the second type may be provided along second partial regions, for example on the prism surfaces.

According to a further advantageous embodiment of the invention, the truncated surface of each of the prisms is directed outward. This allows light-diffusing structures to be provided on the light-exit side in a particularly simple manner.

According to a further preferred embodiment of the invention, the partial regions are provided for achieving a light-scattering effect by use of diffusing structures. The diffusing structures may be applied, for example, by roughening of the surface. Such surface roughening may also be obtained by subsequent machining of the surface of the light-exit side of the prismatic lens after the manufacturing process. For example, a prismatic lens made of glass may be sandblasted to obtain the desired surface roughness. Alternatively, the surface may be machined by other suitable means to achieve the desired degree of roughness and the accompanying desired light-scattering, diffusing effect.

It is noted that surface roughness may also be applied during manufacture of the prismatic lens. Thus, for example, for a prismatic lens made of plastic that is manufactured as a plastic injection-molded part, the desired surface roughness is obtained by sandblasting the mold. The surface roughness present in the mold is imprinted on the exterior of the prismatic lens during the injection molding process.

It is noted that for the prismatic lens according to the invention the light-entry side is kept essentially free of light-diffusing structures.

The diffusing structures on the light-exit side may also be provided by microlenses. For example, the microlenses may be provided in each case only along the truncated surface of the prisms, whereas the surface roughness is provided on the prism flanks, i.e. on the prism surfaces. The microlenses may also be subsequently incorporated into the prismatic lens that, however, entails a greater level of effort. In particular when the prismatic lens is provided as a plastic injection-molded part, it is recommended that the microlenses be incorporated into the mold.

Finally, the diffusing structures may also be obtained by nanostructuring of the surface of the light-exit side of the prismatic lens. Such nanostructuring may, for example, make use of interference effects, thus likewise achieving a light-diffusing effect.

Finally, it is noted that the diffusing structures may extend along the entire light-exit side of the prismatic lens, or only along partial regions of the light-exit side of the prismatic lens. In particular, diffusing structures may be provided only on specific prism flanks, and/or only on the truncated sides of the prisms.

In this regard, it is noted that the prismatic lens according to the invention may be occupied essentially completely by prisms along its light-exit side and/or along its light-entry side. However, the invention also encompasses prismatic lenses in which only partial regions of the light-entry side and/or the light-exit side of the prismatic lens are occupied by prisms.

Finally, the diffusing structures may also be provided by affixing a separate body, in particular a separate film, especially an adhesive film, to the light-exit side of the prismatic lens.

As mentioned above, the prisms may be provided only on the light-entry side of the prismatic lens, for example. In this case the light-exit side of the prismatic lens could have an essentially planar, i.e. smooth, design. This allows a film that extends along the entire light-exit side of the prismatic lens to be affixed in a particularly simple manner. The film may be provided with an adhesive surface, for example, to securely join same directly to the prismatic lens while avoiding optically active boundary surfaces. The outer side of the film may have a desired surface roughness to manifest the desired light-diffusing effects. Alternatively, the film may have a geometric pattern corresponding, for example, to the configuration pattern of the prisms on the light-entry side of the prismatic lens. The pattern of the adhesive film may accordingly contain partial regions that manifest a light-diffusing effect, and other partial regions that do not manifest a light-diffusing effect. In this manner the desired degree of diffusion and light guiding may be obtained. The pattern of the light-diffusing regions provided on the adhesive film may correspond to a pattern of a prism configuration that is present on the light-entry side of the prismatic lens. Thus, for example, it may be ensured that the portions of light to be deflected that pass through the prism surface are diffused to a lesser extent, and the portions of light passing through the truncated surfaces of the prisms are diffused to a greater extent. However, the opposite effect may be desired, such that the portions of light exiting through the truncated surfaces of the prisms are diffused to a lesser extent, and the portions of light exiting through the prism surfaces, i.e. through the surfaces of the prisms that are inclined with respect to the base are diffused to a greater extent.

According to a further advantageous embodiment of the invention, the prismatic lens is made of plastic, in particular PMMA. This allows a particularly simple manufacture.

According to a further aspect, the invention relates to a light fixture according to the preamble of claim 21.

Such a light fixture is known from the prior art and has been marketed by the present applicant, for example, for quite some time.

Proceeding from the known light fixture of the present applicant, the object of the invention is to refine the known light fixture in such a way that light is evened out while maintaining the light-directing function of the prismatic lens.

This object is obtained according to the invention according to the features of claim 21, in particular the features of the characterizing part, and is accordingly characterized in that the light strikes the prismatic lens at a first angle and is deflected by a plurality of prisms arrayed in a structured manner in such a way that after passing through, the light exits the prismatic lens at a second, different angle, and diffusing structures are provided directly on the prismatic lens that at least partially diffuse the light passing through the prismatic lens.

The light fixture according to the invention preferably includes a prismatic lens according to one of claims 1 through 20.

The invention further relates to light fixtures that use prismatic lenses having a rectangular shape and that, for example, emit the light along a single preferred direction. However, the invention also relates to light fixtures that use an essentially rotationally symmetrical prismatic lens and that allow an essentially rotationally symmetrical angular deflection. Such an embodiment is illustrated and explained in the following description of the figures.

In addition, in terms of evaluation and consideration of the advantages described with respect to claims 1 through 20 and of the principles of the invention, the invention may best be understood according to claim 21.

According to one advantageous embodiment of the invention, the light fixture is designed as an axially longitudinally extending floor light fixture, and illuminates a floor surface. This allows a light head, i.e. a region of the light fixture containing the light source and prismatic lens, to be provided in the free, i.e. upper, end section of the light fixture. This also allows one or more light sources to be provided above the prismatic lens. In this manner a very compact light fixture having a small diameter may be constructed that casts a large light cone onto the floor surface to be illuminated.

Multiple LED's are advantageously provided in the light fixture as light sources. These LED's may be oriented with their primary direction of radiation essentially perpendicular to the prismatic lens. Thus, by use of LED's as light sources having a low beam angle, optimized illumination of the floor surface may be obtained without significant losses in luminous flux.

It is also advantageous to provide light sources and prismatic lenses above a cruciform support. The cruciform support may be used, for example, to impart mechanical stability to the light fixture. For the light fixture according to the invention, despite the presence of a cruciform support, illumination of the floor surface may be obtained that avoids the image of the cruciform support structure in the cast shadow. Homogeneous illumination of the floor surface is thus made possible.

Further advantages of the invention result from the uncited dependent and with reference to the following description of several embodiments illustrated in the drawings that show the following:

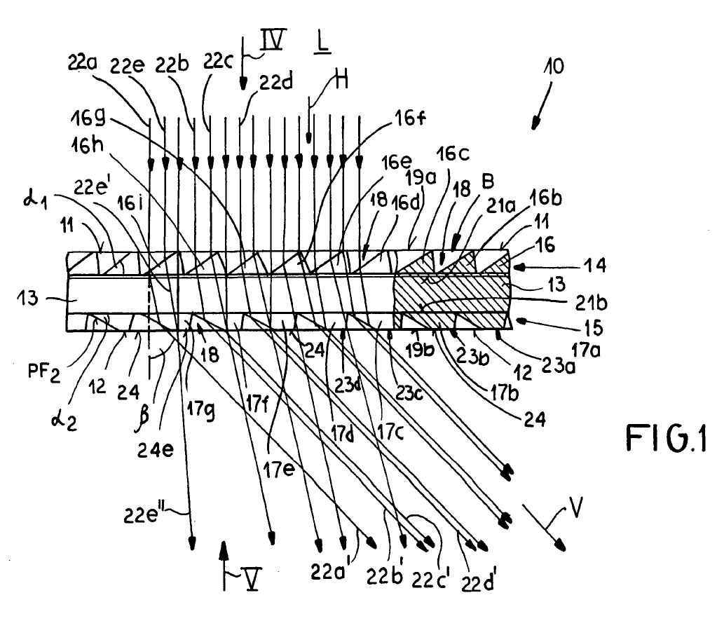

FIG. 1 shows a schematic partial cutaway view of a first embodiment of a prismatic lens according to the invention;

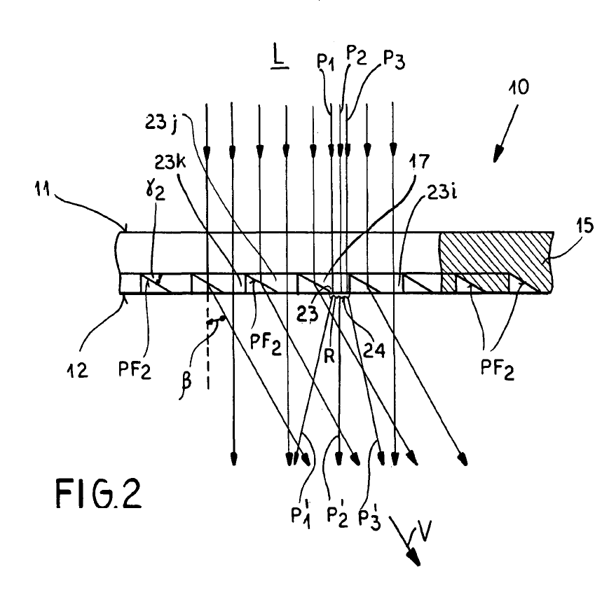

FIG. 2 shows a view like FIG. 1 of a further embodiment of a prismatic lens according to the invention;

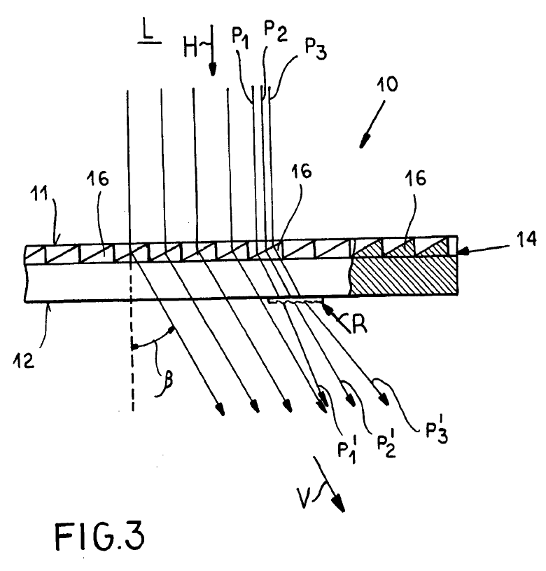

FIG. 3 shows a view like FIG. 2 of a further embodiment of a prismatic lens according to the invention;

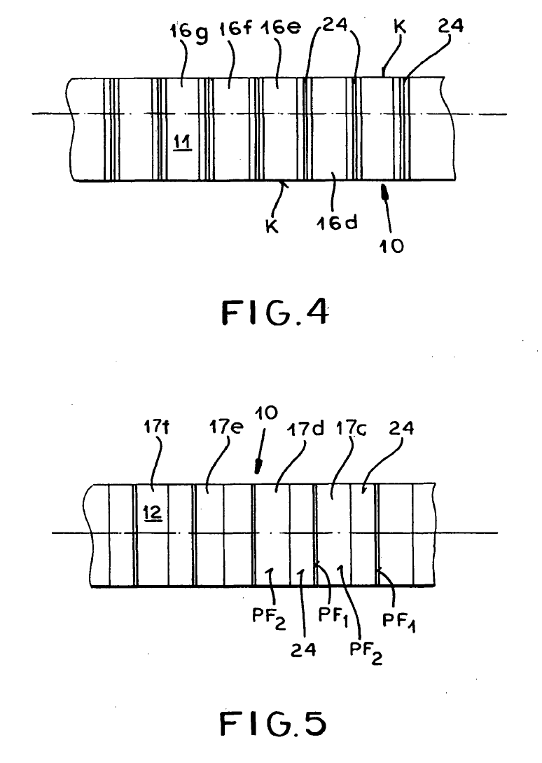

FIG. 4 shows a schematic top view of the embodiment of FIG. 1 in a view according to arrow IV in FIG. 1;

FIG. 5 shows the embodiment of FIG. 1 in a schematic lower view according to arrow V in FIG. 1;

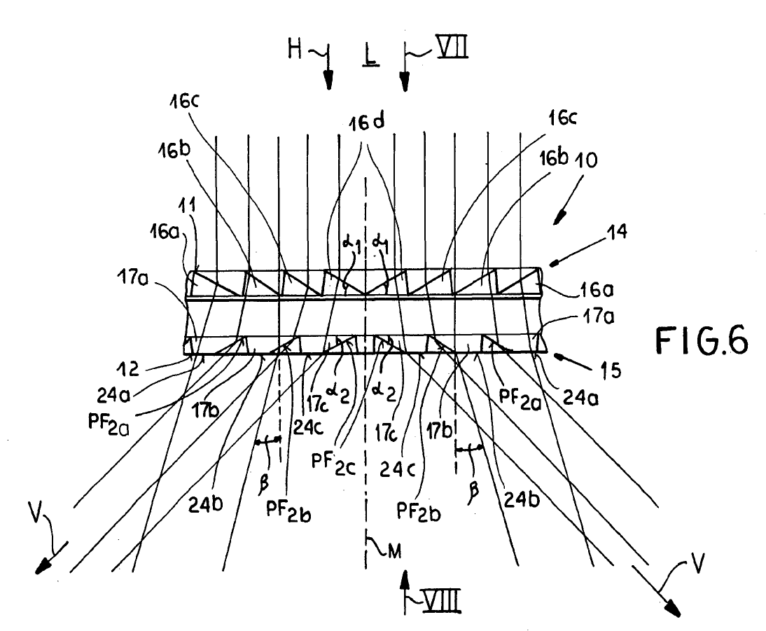

FIG. 6 shows a view like FIG. 1 of a further embodiment of a prismatic lens according to the invention;

FIG. 7 shows the embodiment of FIG. 6 in a top view according to arrow VII in FIG. 6;

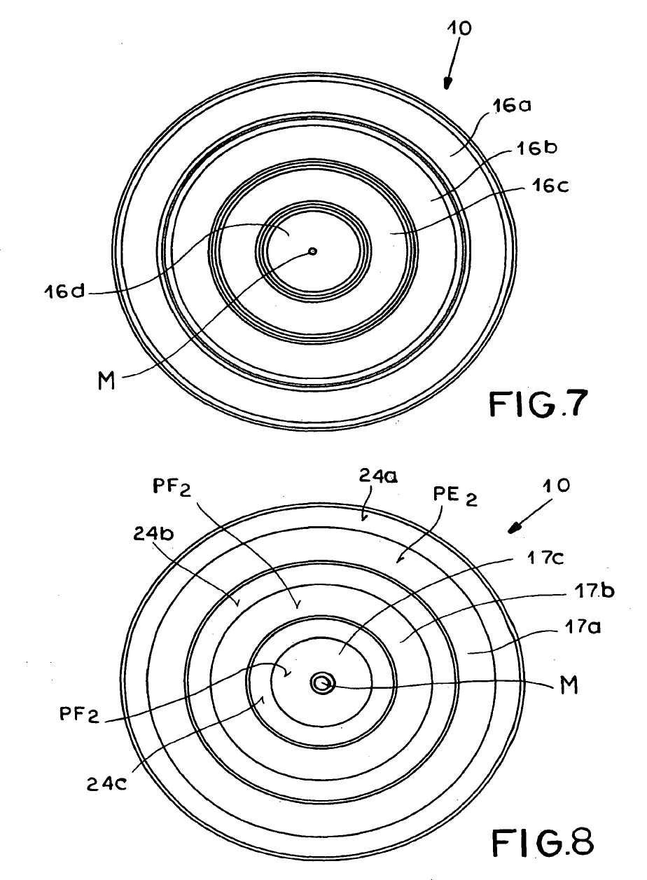

FIG. 8 shows a view like FIG. 7 of the embodiment of FIG. 6 according to arrow VIII in FIG. 6;

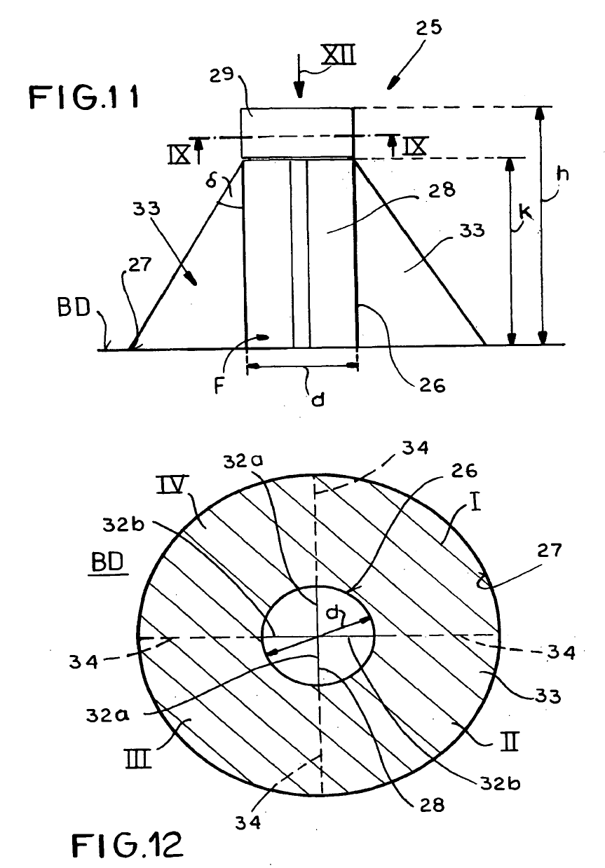

FIG. 9 shows a partially cutaway schematic view, approximately along section line IX-IX of FIG. 11, of a section through one embodiment of a light fixture according to the invention;

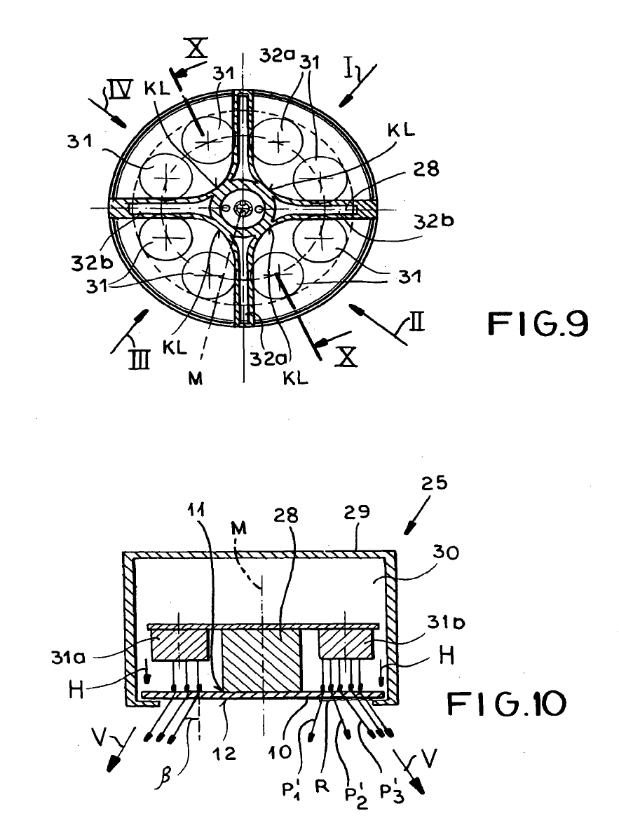

FIG. 10 shows a partially cutaway schematic view, approximately along the section line X-X in FIG. 9, of the light head together with the light source and prismatic lens;

FIG. 11 shows a highly schematic, partially cutaway view of one embodiment of a light fixture according to the invention, including the light distribution produced on a floor surface;

FIG. 12 shows an embodiment of the light according to FIG. 11 in a top view according to arrow XII in FIG. 11 for showing the obtained light distribution;

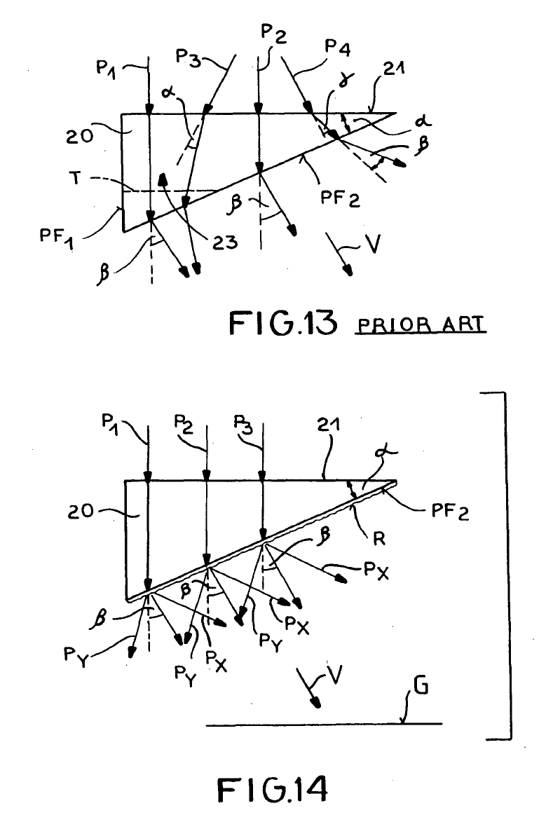

FIG. 13 shows a schematic view of the beam progression through a prism of the prior art; and

FIG. 14 shows a view of the principle of the invention with reference to an individual prism.

The prismatic lens according to the invention generally shown at 10 is first described with reference to the embodiment of FIG. 1.

It is noted that in the following description of the figures, for the sake of clarity identical or equivalent parts, elements, or surfaces are designated by the same reference numerals, sometimes with the addition of lower-case letters.

FIG. 1 shows the prismatic lens 10 according to the invention as a planar, essentially plate-shaped body. A region of the prismatic lens 10 on the right side of FIG. 1, designated by reference character B, is shown in a sectional view for the purpose of illustration. This crosshatched region B shows that the prismatic lens 10 may comprise a single solid body having a center region or section 13, a first array 14 of prisms 16 on the light-entry side 11, and a second array 15 of prisms 17 on the light-exit side 12. The prismatic lens 10 may also be composed of a light-permeable material such glass or plastic, for example PMMA. The light-entry side 11 of the prismatic lens 10 is turned toward a light source not illustrated in FIG. 1 and indicated only by the letter L. The light-exit side 12 is turned away from the light source L and a surface to be illuminated, not illustrated in FIG. 1.

At this point it is noted that the prismatic lens 10 together with its center section and arrays 14 and 15 of prisms is preferably designed in one piece. However, one embodiment of the prismatic lens according to the invention (not illustrated) also comprises multiple sections 13, 14 and 15 that are securely joined to one another, for example glued or welded together, so that no spaces exist between the sections and no optical boundary surfaces are introduced into the light path.

It is noted that a plurality of prisms 16a, 16b, 16c, 16d, 16e, 16f, 16g, etc. is provided on the light-entry side 11, whereas on the light-exit side 12 of the prismatic lens 10 a plurality of prisms 17a, 17b, 17c, 17d, 17e, 17f, 17g, etc. is provided. The number of prisms 16 on the light-entry side may be different from the number of prisms 17 on the light-exit side.

Between every two prisms, for example between prisms 16b and 16c, free spaces 18 are present that are filled with air. With reference to FIG. 1, the free spaces 18 of the prism array 14 open upward. With reference to FIG. 1, the free spaces 18 of the prism array 15 open downward. The sight line designated by reference numeral 19a in FIG. 1 is apparent to an observer of FIG. 1 only when the prisms 16a, 16b, 16c, etc. have a curved progression, as shown, for example, in the embodiment of FIGS. 6 through 8, to be explained in greater detail below. The same applies for the lower sight line 19b with reference to FIG. 1.

Before the course of the light beams in the prismatic lens according to the invention is described, the course of a light beam in a conventional prism of the prior art will be described, with reference to FIG. 13.

FIG. 13 shows a conventional individual prism 20 having a base 21 and two prism surfaces PF₁ and PF₂. Prism surface PF₂ is inclined relative to the base 21 at an acute angle α. In the embodiment of FIG. 13, the acute angle α is approximately 27°.

Light beams P1 and P2 striking the base 21 essentially perpendicularly from above with reference to FIG. 13 are not deflected at the base 21, and enter the prism 20. At the second prism surface PF₂ that is inclined relative to the base 21, refraction occurs in such a way that the beams exiting the prism 20 undergo a deflection by the angle β. The deflection angle β depends on the prism angle α, as well as the index of refraction of the prism material and the color of light.

It is important that all parallel light beams striking the base of the prism 20, represented by beams P1 and P2, also exit the prism surface PF₂ parallel to one another. Therefore, all incident parallel beams are essentially deflected by the same angle β.

In addition, beams that strike the base 21 at a slight inclination, illustrated by light beams P3 and P4, undergo a corresponding deflection. These light beams as well are refracted by the prism boundary surfaces 20, PF₂, and are thereby deflected. In the case of beams that strike the prism surface 21 obliquely, a deflection occurs at the first boundary surface 21 at an angle γ. Another deflection takes place at the second boundary surface PF₂.

Based on knowledge of the mode of operation of a prism 20, the mode of operation of the prismatic lens 10 according to FIG. 1 becomes clear. A plurality of parallel or at least substantially parallel light beams 22a, 22b, 22c, and 22d emanating from the light source L strikes the light-entry side 11 of the prismatic lens 10. These light beams are deflected twice, by prisms 16i, 16h, and 16g of the first array 14 of prisms, and by prisms 17g, 17f, and 17e of the second array 15 of prisms, and exit the prismatic lens as light beams 22a′, 22b′, 22c′, and 22d′.

Analogous to the view of FIG. 13, for the embodiment of FIG. 1 the light beams 22a, 22b, 22c, 22d striking the prismatic lens 10 perpendicular to the light-entry side 11 are deflected by an angle β, and thus along a preferred direction V.

It is completely irrelevant whether the angle β in the embodiment of FIG. 1 is different from the angle β in FIG. 13. The magnitude of the angle β according to FIG. 1 depends on the selection of the prism angles α₁ and α₂ in the prisms of the first prism array 14 and of the second prism array 15.

In contrast to the prism 20 of FIG. 13, prisms 16a, 16b, 16c, 16d, 16e, 16f, 16g and 17a, 17b, 17c, 17d, 17e, 17f, 17g in the embodiment of FIG. 1 are truncated. Truncation is obtained by cutting off an individual prism 20 approximately along a line designated by reference character T in FIG. 13, resulting in a truncated prism 23. For the prism array 15 of the embodiment of FIG. 1, the truncated prisms are designated as 23a, 23b, 23c, 23d by way of example.

For the first prism array 14, truncated prisms may be provided on the light-entry side 11 of the prismatic lens 10, similar to the view in FIG. 1. However, in the embodiment of FIG. 1 these truncated prisms are not as pronounced as for the second prism array 15.

As shown in the schematic view of the light beam progression of incident parallel beams from FIG. 1, the configuration of the plurality of prisms 16a, 16b, 16c, 16d, 16e, 16f, 16g and 17a, 17b, 17c, 17d, 17e, 17f, 17g results in light guiding along a preferred direction V.

The portions of light emitted by the light source L essentially along a primary direction of radiation H substantially perpendicular to the light-entry side 11 of the prismatic lens 10 are deflected essentially along a preferred direction V. Thus, light may be directed to the desired extent by means of the prismatic lens. For example, in certain installation situations or as the result of a predetermined geometry of the light fixture it may be desirable to illuminate regions of a building surface or the like that are located not in the primary direction of radiation H of the light source, but instead are below the prismatic lens 10 on the right side in FIG. 1, i.e. in the direction of the preferred direction V. The light emitted from the prismatic lens 10 may be directed to this surface to be illuminated.

According to the principle of the invention, in the region of the light-exit side 12 of the prismatic lens 10 at least partial regions may have a light-diffusing design. Thus, for example, according to the invention the end faces 24 of the truncated prisms 23a, 23b, 23c, 23d pointing downward with reference to FIG. 1 are provided with a certain surface roughness. The light that reaches these truncated prism surfaces 24 is then diffusely scattered at these rough surfaces. In this manner the light passing through the prismatic lens 10 is evened out.

For clarity, the principle of the invention is first illustrated with reference to an individual prism 20 according to FIG. 14, as follows: For this purpose it is assumed that the prism of FIG. 13 is provided on its prism surface PF₂ with a particular surface roughness, designated by reference character R in FIG. 14. In the case of a prism structure 20 made of glass, the surface roughness may be provided, for example, by sandblasting the prism surface PF₂.

According to FIG. 14, the incident parallel light beams P1, P2, and P3 are deflected by the prism angle α along the preferred direction V. As the result of the surface roughness R, however, portions of the light beams designated by light arrows Px and Py are also deflected along directions other than the preferred direction V. In this manner the light passing through the prismatic lens is homogenized, i.e. evened out. At the same time, however, the light-directing effect is also diminished. The light-directing effect decreases by the degree to which diffuse properties of the prism surface PF₂ increase. The more portions of light Px and Py that exit the prism surface PF₂ in a direction other than the preferred direction V, the fewer portions of light that are cast along the preferred direction V onto the building surface G.

However, the invention uses diffusely scattering structures in such a way that a light-directing effect may be maintained, for example by application of a special type of diffusing structures, such as a certain surface roughness, or by providing diffusing structures only along sections or portions or partial regions of the light-exit side of the prismatic lens.

The building surface indicated in FIG. 14 and designated by reference character G may thus be illuminated with a softer light than would be possible without an array having a surface roughness R. At the same time, the following effect is obtained: the luminance is evened out on the light-exit side 12 of the prismatic lens 10. This allows the structures of the light sources, observed through the prismatic lens, to be resolved and evened out to a greater extent.

The embodiment of FIG. 1 makes use of the principle of the invention. In this case, for example, all truncated prism surfaces 24 are provided with surface roughness. However, for the sake of clarity these are not illustrated in FIG. 1. Alternatively, the inclined prism surfaces PF₂ of the second prism array 15 may be additionally or solely provided with such light-diffusing structures on the light-exit side 12 of the prismatic lens 10. The latter are also not illustrated for the sake of clarity.

FIG. 1 also illustrates that for the prismatic lens 10 according to the invention, not all the parallel light beams that strike the light-exit side 11 along the primary direction of radiation H are deflected along the preferred direction V. Thus, for example, with reference to the schematically illustrated beam path of the incident light beam 22e, it is shown that this light beam is first deflected by the prism 16i (see light beam section 22e′), and then strikes the truncated surface 24e of the associated prism 17g. In this manner the light beam is not deflected again, depending on the circumstances, and exits the prismatic lens 10 as light beam 22e″.

All the light beam portions exiting the prismatic lens 10 through the truncated surfaces 24 emerge from the prismatic lens 10 at different angles. The effects that contribute to evening out the light distribution are further increased by application of diffusing structures to the truncated surfaces 24.

FIG. 2 shows an alternative embodiment of a prismatic lens 10 according to the invention in a view like that of FIG. 1. In the present case the first prism array 14 has been omitted. The prismatic lens 10 thus has only a second prism array 15 on the light-exit side 12. The light-entry side 11 of the prismatic lens 10 has a continuously flat, i.e. smooth, design.

The parallel light beams radiated from the light source L strike the light-entry side 11 of the prismatic lens 10 essentially perpendicularly, and are deflected by an angle β along a preferred direction V.

Assuming a prism angle γ₂ in the embodiment of FIG. 2 that is identical to that of the embodiment of FIG. 1, the deflection angle β0 in the embodiment of FIG. 2, for example, is smaller than the deflection angle β in the embodiment of FIG. 1. The reason is that the first prism array 14 on the light-entry side 11 has been omitted in this embodiment, and in this regard only a light-directing boundary surface is provided.

In the embodiment of FIG. 2, all truncated surfaces of the prisms may likewise be provided with roughness or other diffusing structures. For reasons of clarity, in the embodiment of FIG. 2 this is illustrated only for the truncated prism designated by reference numeral 23. This truncated prism 23 is provided on its truncated prism side 24 with a special surface roughness R.

The three closely adjacent, incident parallel light beams P1, P2, and P3 are diffusely scattered corresponding to the nonuniform boundary surface 24. This is illustrated by the penetrating light beam portions P1′, P2′, and P3′.

For the sake of clarity, only the truncated prism designated by reference numeral 23 is illustrated with surface roughness R in FIG. 2. However, the other truncated prisms 23i, 23j, 23k may advantageously have comparable diffusing structures on their truncated prism surfaces 24.

Similarly, in the embodiment of FIG. 2 it is possible for only the prism surfaces PF₂ to be provided with diffusing structures, in particular surface roughness. According to the selected view of the embodiment of FIG. 2, however, only the truncated prism surfaces 24 are provided with diffusing structures, whereas the prism surfaces PF₂ are free of diffusing structures.

In a further embodiment according to FIG. 3, a prismatic lens 10 has a first array 14 of prisms 16 only on its light-entry side 11. Here as well, the light emitted by a light source L along a primary direction of radiation H is deflected by a deflection angle β along a preferred direction V.

In this embodiment the light-exit side 12 has an essentially planar design. This allows a particularly simple and, for example, also a continuous machining of the light-exit side 12. For example, in the case of a prismatic lens made of glass the entire light-exit side 12 of the prismatic lens 10 may be sandblasted. Alternatively, any other suitable machining by use of other means is also possible.

At this point it is noted that the diffusing structures according to the invention on the light-exit side 12 may also be created by application of a film, for example. This film may be adhered directly to the light-exit side 12, for example. The side of the film facing away from the light source L may, for example, be provided with a corresponding surface roughness to achieve the desired light-scattering, i.e. diffusive, effect. The embodiment of FIG. 3 is particularly advantageous when a separate film is applied to the prismatic lens 10, since in this case the film may be adhesively bonded in a planar manner along the entire light-exit side 12 or affixed by other suitable means. Use of a film is advantageously possible within the scope of the invention, since as a result of directly applying the adhesive film to the underside of the prismatic lens 10 the production of optically active boundary surfaces and reflection losses may be avoided, thereby achieving a high luminous flux efficiency.

For clarity of the view, in FIG. 3 as well only a small partial region of the light-exit side 12 is shown provided with a surface roughness R. Here as well, the light beam bundle of closely adjacent, incident parallel light beams P1, P2, P3 illustrates that a diffusion effect may be obtained. The emerging light beams that are diffusely scattered by the surface roughness are designated by reference numerals P1′, P2′, P3′, respectively.

It is noted that light-scattering diffusing structures are applied on or incorporated into the light-exit side 12 of the prismatic lens 10 to an extent such that there is little or no impairment of the desired guiding of light through the prisms. This may be obtained, for example, by providing only a portion of the light-exit side 12 of the prismatic lens 10 with light-diffusing structures, or by the fact that the light-diffusing structures themselves manifest a diffusive scattering effect only to a predetermined degree.

FIG. 4 shows the embodiment of the prismatic lens 10 according to FIG. 1 in a schematic top view, approximately along the viewing direction of an observer of arrow IV in FIG. 1. Thus, the light-entry side 11 of the prismatic lens 10 is visible to the observer of FIG. 4.

Firstly, it is apparent that the shape K according to the broken view in FIG. 4 has an essentially rectangular design. The individual prisms 16d, 16e, 16f, 16g thus extend essentially in parallel. However, it is clear to the observer of FIG. 4 that the drawing is not to scale. The rectangular shape may be selected in any given manner with respect to its width and length, so that, for example, the prismatic lens 10 may be placed in a light exit opening of a light fixture. In this regard, the shape K of the prismatic lens 10 is advantageously matched to the shape of the light exit opening of a light fixture, and corresponds thereto.

The top view according to FIG. 4 shows the truncated prism surfaces 24 of the light-exit side 11 that, however, are not as pronounced as the truncated prism surfaces 24 on the light-exit side 12 of the prismatic lens 10 according to FIG. 1.

For a better explanation of the relationship of the figures, it is noted once again that FIG. 1 is a schematic view approximately along the section line I-I in FIG. 4, or similarly, a sectional view of the prismatic lens 10 according to FIG. 5 approximately along the section line I-I.

FIG. 5 shows the light-exit side 12 of the prismatic lens 10, and thus corresponds to a bottom view according to arrow V in FIG. 1. Shown here are prisms 17c, 17d, 17e that, analogously to FIG. 4, extend longitudinally and in parallel, and are thus oriented along parallel straight lines. FIG. 5 also clearly shows the two prism surfaces PF₁ and PF₂, as well as the truncated prism surface 24 situated therebetween.

The diffusing structures are also not illustrated in FIGS. 4 and 5 for the sake of clarity.

In the embodiment of FIGS. 6 through 8, in contrast to the embodiment of FIGS. 4 and 5 the numerous prisms extend along circular lines, not straight lines. In this regard, the embodiment of FIG. 6 may be considered as a continuation of the embodiment of FIG. 1, farther to the left and with a mirror-image configuration of prism structures 14 and 15.

The prismatic lens 10 according to FIG. 6 is an essentially circular disk-shaped body, and likewise has a light-entry side 11 and a light-exit side 12. A first structure 14 having prisms 16a, 16b, 16c, 16d is provided on the light-entry side 11, and on the light-exit side 12 a second array 15 of prisms 17a, 17b, 17c is provided.

For clarity, it is assumed in this case that the prism angles α₁, α₂ used are the same as in the embodiment of FIG. 2.

The light emitted from the light source L along the primary direction of radiation H is deflected through the prisms by an angle β along a radial preferred direction V. The radial preferred direction V is intended to illustrate, in the sense of claim 1 of the present patent application that two mirror-image, reversed preferred directions may be seen in the view of a sectional view through the prismatic lens, transverse to the planar longitudinal extension thereof. This is based on the mirror-image, rotationally symmetrical configuration of the prisms. On account of the rotationally symmetrical configuration of the prismatic lens 10 and of the prism structures 14 and 15, this may be regarded as a preferred direction V that radially, i.e. rotationally symmetrically, rotates about a longitudinal center axis M of the prismatic lens in the sense of claim 1.

FIGS. 7 and 8 show the embodiment of the prismatic lens 10 according to FIG. 6 in top view and bottom view, respectively. FIG. 7 shows prisms 16a, 16b, 16c, and 16d in an annular, i.e. concentric, configuration. FIG. 8 shows, in a bottom view according to arrow VIII, the lower prisms 17a, 17b, and 17c, likewise in an annular configuration. FIG. 8 also clearly shows the truncated prism surfaces 24a, 24b, and 24c.

According to one embodiment of the invention, the truncated prism surfaces 24a, 24b, 24c, which have an annular layout, are provided with diffusively acting, light-scattering diffusing structures. For example, the truncated prism surfaces 24a, 24b, and 24c may each be provided with surface roughness. At the same time, the flanks of prisms 17a, 17b, and 17c, i.e. the prism surfaces PF₂ₐ, PF_{2b}, and PF_{2c}, are free of diffusively acting diffusing structures.

In this embodiment, the light-diffusing partial regions according to claim 1 of the present patent application are thus provided only by the truncated prism surfaces 24a, 24b, and 24c.

It is noted that in the embodiment of FIGS. 6 through 8 the number of annularly arrayed prisms 16, 17 may be arbitrarily selected. The thickness and diameter of the prismatic lens 10 may also be freely selected.

In one embodiment of the prismatic lens according to the invention corresponding to FIGS. 6 through 8, the diameter is approximately 11 cm, for example. In this prismatic lens, for example, sixteen prisms 16 may be provided on the light-entry side 11 of the prismatic lens 10, and fourteen prisms 17 may be provided on the light-exit side 12 of the prismatic lens 10.

A light fixture 25 according to the invention that uses a prismatic lens 10 according to the invention corresponding to FIGS. 6 through 8 is described below, with reference to the embodiment of FIGS. 9 through 12.

FIG. 11 shows a light fixture collectively designated by reference numeral 25. The light fixture has an essentially axially longitudinal extension, and has a height h. The light fixture includes a luminous element 26 having an essentially circular cylindrical structure with a diameter d.

The light fixture 25 is designed as a floor light fixture, and with its base region F is affixed to the floor BD of a building or preferably an exterior space. The light fixture 25 is intended to illuminate the floor BD as uniformly as possible within a circle of illumination 27.

The light fixture 25 has a cruciform support 28 composed of two walls 32a, 32b extending at 90° (FIG. 9) to each other. These walls in particular have a nonreflective design, and are painted matte black, for example. The cruciform support 28 extends over a height k.

The light head 29 is above the cruciform support 28, and is illustrated separately in FIG. 10. The light head 29 has a housing-like design, and has an interior space 30 for accommodating light sources 31a and 31b. As illustrated in particular in FIG. 9, two LED's 31, for example, may be accommodated in each of the four quadrants I, II, III IV that are separated from one another by the walls 32a and 32b of the cruciform support 28. Of course, other lighting means may be considered as light sources. The number of lighting means may also be freely selected. However, it is advantageous for an identical number of lighting means to be accommodated in an essentially rotationally symmetrical configuration in each of the four quadrants I, II, III IV according to FIG. 9.

According to FIG. 10, light sources 31a and 31b radiate downward, essentially along a primary direction of radiation H. The emitted light strikes the light-entry side 11 of a prismatic lens 10 according to the invention corresponding to FIGS. 6 through 8. After passing through the prismatic lens 10, as a result of the prism array the light emerges from the prismatic lens 10, deflected by an angle β, along the preferred direction V. Similarly as described for the embodiment of FIG. 6, the preferred direction V rotates in a rotationally symmetrical manner so that the light cone that is produced spans a truncated cone body.

In the light fixture 25 according to the invention corresponding to FIG. 10, the prismatic lens 10 according to the invention is provided with diffusing structures on the light-exit side 12. As previously described, these diffusing structures may be formed, for example, by surface roughness on partial regions of the light-exit side 12. In FIG. 10, arrows P1′, P2′, and P3′ are intended to show, corresponding to the view in FIG. 3 that light diffusion occurs in the region of the light-exit side 12 of the prismatic lens 10. As a result, the light cone 33 produced by the light fixture 25 is substantially evened out. The light cone 33 has a beam angle δ that corresponds to the deflection angle β.

The annular surface on the floor area BD to be illuminated, illustrated in crosshatch in FIG. 12, may thus be uniformly illuminated.

By use of the prismatic lens 10 according to the invention, it is possible in particular to prevent the continuation of the illustrated structure 34 of the cruciform support 28, shown in dashed lines in FIG. 12, from being apparent as a cast shadow in the illumination distribution curve. Between every two adjacent quadrants, for example between quadrants III and IV of the illumination field of FIG. 12, there is a certain overlapping of light distributions, so that the extension 34 of the cruciform support 28 shown in dashed lines in FIG. 12 is not seen as a shadow on the floor area BD to be illuminated.

It is noted that the embodiments of the invention merely indicate the teaching according to the invention. The roughness for achieving a diffusing structure may be obtained, for example, by sandblasting a prismatic lens 10 made of glass. In the case of a prismatic lens according to the invention made of plastic, the desired surface roughness may be obtained, for example, by sandblasting the mold for the plastic injection-molded part and imprinting the roughness of the mold into the plastic injection-molded part.

In addition to surface roughness, other suitable means such as lenses or surface structures that are able to achieve a light-scattering effect may be considered as light-diffusing structures in the sense of the present invention. Light-diffusing structures in the sense of the present invention are structures that are able to contribute to blending of the light, homogenization, and evening out.

The light-diffusing structures are applied only to the light-exit side of the prismatic lens. The structures may extend along the entire light-exit side of the prismatic lens, or only along surface sections of the light-exit side.

The embodiments of FIGS. 1 through 14 show prisms 16, 17, 20 having a base 21, a first prism surface PF₁ essentially perpendicular thereto, and a second prism surface PF₂ oriented at an acute angle relative to the base. However, it is noted that the invention also encompasses prismatic lenses whose prisms have two prism surfaces PF₁ and PF₂ that are both inclined at an acute angle relative to the corresponding base 21.

It is further noted that the invention also encompasses prismatic lenses that, as in the case of the embodiment of FIG. 1, have double prisms. In this regard, the mutually opposite configuration of the prism 16c on the light-entry side 11 and of the prism 17b on the light-exit side 12, for example, may be regarded as a type of double prism having two bases 21a and 21b.

Within the scope of the present description of the figures, only the embodiments for which the prisms 16, 17 are truncated and in each case have a correspondingly truncated surface 24 are described and illustrated. However, the invention also encompasses prismatic lenses whose prisms are not truncated, but that instead have a cross section as illustrated in FIG. 13, for example.

According to the present patent application, the diffusing structures may be provided only on the prism surfaces on the light-exit side of the prismatic lens, or only on the truncated surfaces of the prisms on the light-exit side, or only on certain prism surfaces, or only on certain truncated surfaces, or only along sections of the prism surfaces, or only along sections of the truncated surfaces.

Finally, it is noted that the prismatic lens according to the present invention does not necessarily have to be continuously occupied by prisms. Depending on the desired application, the invention includes the case that only one surface section of the prismatic lens, for example only one surface section of the prismatic lens extending along a specified circumferential angular range, has prism structures.

Finally, with regard to the embodiment of FIGS. 9 through 12 it is noted that, provided that a prismatic lens 10 according to the embodiment of FIGS. 6 through 8 is used, the radially inner region is preferably free of prisms, since at this location guiding of light is not possible or desired. With reference to FIG. 9, the prism rings thus extend outside a circular line KL around the longitudinal center axis M. This is obvious, since the walls 32a and 32b of the cruciform support 28 in the region radially inside the circular line KL prevent light transmission due to the light-impermeable design of the walls 32a, 32b.

1. A prismatic lens for a light fixture, comprising a light-entry side and a light-exit side, and comprising a plurality of prisms arrayed in a structured manner and used for directing light along a preferred direction, wherein at least partial regions of the light-exit side have a light-diffusing design.

2. The prismatic lens according to claim 1 wherein the prisms are longitudinally elongated.

3. The prismatic lens according to claim 2 wherein the prisms each extend along a straight line.

4. The prismatic lens according to claim 2 wherein the prisms each extend along a circle.

5. The prismatic lens according to claim 1 wherein the prisms are provided on the light-entry side of the prismatic lens.

6. The prismatic lens according to claim 1 wherein the prisms are provided on the light-exit side of the prismatic lens.

7. The prismatic lens according to claim 1 wherein the prisms are truncated.

8. The prismatic lens according to claim 7 wherein a truncated surface of each of the prisms is directed outward.

9. The prismatic lens according to claim 7 wherein a truncated surface of each of the prisms has a light-diffusing design.

10. The prismatic lens according to claim 1 wherein each of the prisms has a base that is turned toward a center section or a center plane of the prismatic lens.

11. The prismatic lens according to claim 1 wherein the partial regions are provided with diffusing structures for achieving a light-scattering effect.

12. The prismatic lens according to claim 11 wherein the diffusing structures are formed by roughness on the surface.

13. The prismatic lens according to claim 11 wherein the diffusing structures are formed by microlenses.

14. The prismatic lens according to claim 11 wherein the diffusing structures are formed by nanostructuring of the surface of the prismatic lens that in particular allows use to be made of interference effects.

15. The prismatic lens according to claim 11 wherein the diffusing structures are formed by machining the surface of the prismatic lens after the manufacturing process.

16. The prismatic lens according to claim 11 wherein the diffusing structures are formed by incorporation into the surface of the prismatic lens during the manufacturing process.

17. The prismatic lens according to claim 11 wherein the diffusing structures are formed by affixing a separate body to the light-exit side of the prismatic lens.

18. The prismatic lens according to claim 11 wherein the prisms are truncated and each of the structures is provided on the truncated surface of the prisms.

19. The prismatic lens according to claim 1 wherein the prismatic lens is made of plastic.

20. The prismatic lens according to claim 19, wherein the prismatic lens is formed from a plastic injection-molded part.

21. A light fixture for illuminating a surface of a building or an exterior surface, comprising at least one light source and at least one light-permeable prismatic lens that is provided in a light path between the light source and the surface to be illuminated wherein light strikes the prismatic lens at a first angle and is deflected by a plurality of prisms arrayed in a structured manner in such a way that, after passing through, the light exits the prismatic lens at a second, different angle, and diffusing structures are provided directly on the prismatic lens that at least partially diffuse the light passing through the prismatic lens.

22. The light fixture according to claim 21, further comprising a prismatic lens having a light-exit side that is at least partially constituted to diffuse light and a light-entry side, the lens comprising a plurality of prisms arrayed in a structured manner and used for directing light along a preferred direction.

23. The light fixture according to claim 21 wherein the light fixture is designed as an axially longitudinally extending floor light fixture, and illuminates a floor surface.

24. The light fixture according to claim 23 wherein the light source is provided in the upper free end section of the light fixture above the prismatic lens.

25. The light fixture according to claims 21 wherein multiple LED's are provided in the light fixture as light sources.

26. The light fixture according to claim 25 wherein the LED's are oriented with their primary direction of radiation essentially perpendicular to the prismatic lens.

27. The light fixture according to one of claims 21 wherein the prismatic lens is situated above a cruciform support.
